(19) United States
(12) Patent Application Publication
(10) Pub. No.: US 2014/0239232 A1
(43) Pub. Date: Aug. 28, 2014

(54) APPARATUS AND METHOD FOR HYDROCARBON PYROLYSIS

(71) Applicants: Vernon Eric Staton, Lexington, VA (US); James Michael Lawrence, Plano, TX (US)

(72) Inventors: Vernon Eric Staton, Lexington, VA (US); James Michael Lawrence, Plano, TX (US)

(21) Appl. No.: 14/127,246

(22) PCT Filed: Jun. 19, 2012
(86) PCT No.: PCT/US2012/043193

§ 371 Date: May 13, 2014

Related U.S. Application Data
(60) Provisional application No. 61/571,130, filed on Jun. 21, 2011.

(51) Int. Cl. B01J 6/00; C01B 3/24

(52) U.S. Cl. CPC B01J 6/008; C01B 3/24
USPC 252/373; 422/186.21

(57) ABSTRACT

The present invention discloses a pyrolysis unit that operates using a plasma pyrolysis reactor. Hydrocarbon material that is to be converted to syngas can be in gas, liquid and/or solid form including a slurry of very small powder particles. The hydrocarbons are subjected to very high levels of heat from one or more plasma torches in order to break the hydrocarbon chemical bonds. The residue from heating the hydrocarbon material drops into a pyrolysis unit quench section where the residue and molten ash are removed. Syngas that is extracted from the pyrolysis unit passes through syngas preparation processes that remove contaminants from the syngas. The syngas then passes through a syngas-to-liquid hydrocarbons process. Carbon dioxide that is removed from the syngas preparation and syngas-to-hydrocarbons processes is recycled to the pyrolysis unit.

This patent application claims priority to U.S. Provisional Patent Application No. 61/571,130 filed Jun. 21, 2011, which is incorporated in its entirety herein by reference.

### TECHNICAL FIELD OF THE INVENTION

This patent application relates generally to the field of synthesis gas production and more specifically to an improved apparatus and method for increasing the efficiency of synthesis gas production.

### BACKGROUND OF THE INVENTION

Hydrocarbon material comprises matter that includes hydrogen and carbon. Hydrocarbon material exists in several forms. One of the common forms of hydrocarbon material is coal. The present invention will be described using coal as an example of hydrocarbon material. It is understood, however, that the present invention is not limited to the production of synthesis gas from coal but is generally applicable to the production of synthesis gas from any type of hydrocarbon material.

Coal gasification is a chemical process that is used to convert coal to carbon monoxide gas and hydrogen gas. The mixture of carbon monoxide gas and hydrogen gas is called synthesis gas (also generally referred to as “syngas”). In the 1920s two German researchers named Franz Fischer and Hans Tropsch invented a catalyzed chemical reaction process (the Fischer-Tropsch process) in which carbon monoxide gas and hydrogen gas may be converted into liquid hydrocarbons of various forms. Typical catalysts that are used in the process are based on iron and cobalt. The principal purpose of the process is to produce a synthetic petroleum substitute for use as synthetic lubrication oil or as synthetic fuel.

Advances in syngas production include plasma pyrolysis which has been applied to the production of syngas from biomass. Pyrolysis is the thermochemical decomposition of organic material at elevated temperatures without the participation of oxygen. Plasma pyrolysis applied to syngas production is the breakdown of hydrocarbon molecular bonds into a gaseous form using plasma torches.

Advances in the syngas-to-liquids production include modifications to the Fischer Tropsch process and the development of alternative methods such as Mobile Olefins to Gasoline Distillate (MOGD) and other technologies of producing liquid hydrocarbon products from syngas.

The original Fischer-Tropsch process is described by the following chemical equations:

$$\begin{matrix}{CH}_{4} + \frac{1}{2} {O}_{2} \to 2 {H}_{2} + CO + heat & ( 1 ) \\ ( 2 n + 1 ) {H}_{2} + n CO \to {C}_{n} {H}_{2 n + 2} + n {H}_{2} O & ( 2 )\end{matrix}$$

The step that is described in Equation (1) is the coal gasification process from methane feedstock. The step that is described in Equation (2) is the Fischer-Tropsch liquefaction process. Liquefaction is the change of a substance from a solid or gaseous state to a liquid state. The utility of the Fischer-Tropsch process is primarily in its role in producing fluid hydrocarbons or hydrogen from a solid feedstock such as coal or solid carbon-containing waste. It is well known that non-oxidative pyrolysis of the solid material produces syngas which can be used directly or as a fuel without being taken through the Fischer-Tropsch process. If liquid petroleum-like fuel, lubricant or wax is desired, the Fischer-Tropsch process may be applied.

FIG. 1 illustrates a block diagram 100 showing a prior art relationship of a coal gasification step 110 and a Fischer-Tropsch process step 120. Coal is provided to the coal gasification step 110 where the coal is converted into syngas. The syngas may be used directly to generate ammonia fertilizers, methanol, dimethyl ether (DME), propylene, electricity, synthetic natural gas, hydrogen and carbon dioxide. The syngas that is provided to the Fischer-Tropsch process step 120 is used to generate liquid hydrocarbons fuel, kerosene, jet fuel, naphtha, gasoline, detergents, waxes, lubricants, steam and electricity.

Various types of equipment and methods have been devised to carry out the process of coal gasification. A coal gasification reaction chamber is generally referred to as a coal gasifier. FIG. 2 illustrates diagram of a typical prior art coal gasifier 200. Organic materials (potentially in the form of coal) are provided from a slurry prep unit 210. The coal from the slurry prep unit 210 is mixed with oxygen from an oxygen generation unit 220. The mixture of coal and oxygen is ignited and burns within a gasifier chamber 230 of the coal gasifier 200. The gasifier chamber 230 operates at a temperature that is typically greater than 2,300 degrees Fahrenheit (2,300° F.) in a reduced oxygen (O₂) environment. This partial combustion process is carried out as a controlled chemical reaction at pressures up to 1,200 pounds per square inch (gauge) (1,200 psig). The combustion process breaks the chemical bonds of the hydrocarbon elements of the coal within a few seconds. The gaseous products of the combustion are carbon monoxide (CO) and hydrogen (H₂). These gaseous products comprise the syngas this is removed from the coal gasifier 200.

By-products of this combustion process are hydrogen sulfide (H₂S), carbon dioxide (CO₂), steam and slag. Slag is the term used to refer to incombustible particulate matter such as the inert minerals, silica and ash that remains after combustion of the typical coal. As shown in FIG. 2 the lower portion of the coal gasifier 200 comprises a quench section 240 in which gases and molten ash are quenched in a circulating water bath. The slag is removed from the bottom of the coal gasifier 200 as an inert glassy material that is referred to as vitrified slag.

The syngas is provided to a cooling unit/steam generator 250. Heat from the syngas is removed by the cooling unit/steam generator 250 by heat exchange. The heat that is removed from the syngas is used to generate steam. After the syngas is removed from the cooling unit/steam generator 250 the syngas is provided to a series of gas clean-up steps in a gas clean-up unit 260. The gas clean-up unit 260 applies various solvents and absorbent materials to remove undesired materials from the syngas. For example, the gas clean-up unit 260 can remove up to ninety five percent (95%) of volatile mercury and up to ninety nine point nine percent (99.9%) of sulfur. The gas clean-up unit 260 also captures and removes carbon dioxide (CO₂) gas that is present in the syngas. The syngas that is output from the gas clean-up unit 260 generally comprises only carbon monoxide (CO) and hydrogen (H₂).

The coal gasifier 200 that is described above operates on a principle of combustion. Other methods of coal gasification operate on principles that employ a pyrolysis process. Pyrolysis is defined as thermal decomposition of carbon-based materials in an oxygen deficient (starved) atmosphere using heat to produce syngas. The operating temperature in a typical pyrolysis reactor is between one thousand two hundred degrees Fahrenheit (1,200° F.) and two thousand two hundred degrees Fahrenheit (2,200° F.). No air or oxygen is present and no direct burning takes place.

Plasma arc gasification is another method that is used to extract syngas from coal. One or more plasma arc units are used to generate very high temperatures in order to dissociate the chemical bonds in organic material that is fed to a gasifier chamber. The operating temperature in a typical plasma arc gasification reactor is between seven thousand two hundred degrees Fahrenheit (7,200° F.) and twelve thousand six hundred degrees Fahrenheit (12,600° F.). For additional details concerning pyrolysis processes and plasma arc gasification one may consult the book Municipal Solid Waste To Energy Conversion Processes by Gary C. Young published by John Wiley & Sons, Inc. in 2010.

In the process of syngas production it is desirable to increase efficiency and reduce costs. Therefore, there is a need in the art for improved methods of syngas production.

### BRIEF SUMMARY OF THE INVENTION

The present invention discloses a hydrocarbon pyrolysis unit that operates using a plasma based pyrolysis process. The hydrocarbon pyrolysis unit comprises a reactor vessel that may withstand very high plasma temperatures. Hydrocarbon material in a solid form (e.g., coal) is delivered to a pulverizer unit that breaks up the hydrocarbon material into very small particles that are then converted into a slurry through the addition of steam. A pump/conveyer unit delivers the hydrocarbon slurry to a pyrolysis reaction chamber of the reactor vessel. Hydrocarbons in liquid or gas form can also be delivered to the pyrolysis reaction chamber. The pyrolysis reaction chamber is designed to accommodate one or more strategically located plasma torches. The structure and operation of one particular plasma torch are described in U.S. Pat. No. 7,446,289 and in U.S. Patent Application Publication No. 2009/0261080. The plasma torch uses an electric device (e.g., electrodes) to turn a plasma burner gas (e.g., carbon dioxide, steam and/or oxygen) into plasma. The plasma is immediately moved into an area where a specially designed combination of electromagnets, rare earth magnets, and/or other magnets squeeze the plasma to a higher temperature and contain it over a longer distance than what would normally be expected by the electric device alone. The plasma gas comes into contact with hydrocarbon material that is injected into the pyrolysis reaction chamber and interacts with the plasma. As the plasma travels in the pyrolysis reactor, the momentum, pressure and temperature of the plasma break up the hydrocarbon material.

For a minimal input power, an initial plasma of a few thousand degrees Kelvin over a few inches can be generated. With the extra configuration of magnetic field it is estimated that this initial plasma temperature can be raised to several hundred thousand degrees Kelvin for a few feet or more. This temperature range and distance allows for maximum generation of high quality syngas. The plasma stability that is obtained by using the plasma torch technology allows greater field strength for very little input power. Plasma torch technology uses increased plasma temperature, density and momentum to break down the chemical bonds most efficiently by creating a “magnetic nozzle” that confines and directs the main magnetic field on target within the torch layout of the pyrolysis chamber.

The feed entering the plasma pyrolysis reaction chamber may be a combination of hydrocarbons in liquid, gas and/or solid state which is subjected to very high levels of heat, pressure and momentum in the plasma pyrolysis reaction chamber to break the chemical bonds between the atoms of carbon and hydrogen of the hydrocarbon material. The heat in the plasma pyrolysis reaction chamber is provided by one or more plasma torches that are strategically located in a plasma heating chamber of the reactor vessel to produce an efficient pyrolysis zone.

The plasma torches are directed by a control system providing the optimal plasma gas feed rate and power level using temperature and magnetic field sensors. Additionally the hydrocarbon feed rate and composition are controlled to provide an efficient pyrolysis system while also producing an optimal syngas ratio for a particular downstream syngas-to-liquid process.

The syngas that is produced in the pyrolysis reaction chamber and in the plasma heating chamber flows from the hydrocarbon reactor vessel. The syngas may pass through an internal heat exchanger to cool the syngas. The residue solids from heating the hydrocarbon slurry falls into a pyrolysis reactor molten bath section where the molten residue is collected. The metals and other inorganic materials in the lower portion of the reactor vessel quench section are subjected to resistive heating in a pool of molten glass materials. The metals and other inorganic materials and the molten glass are subsequently removed from the bottom of the reactor vessel.

Recycle carbon dioxide (CO₂) loops are provided from downstream syngas cleaning and/or syngas-to-liquids process operations. The recycle carbon dioxide is fed to the pyrolysis reactor as an inert gas to supply the plasma media and to provide carbon and oxygen upon thermal dissociation.

### BRIEF DESCRIPTION OF THE DRAWINGS

For a more complete understanding of the features and advantages of the present invention, reference is now made to the detailed description of the invention along with the accompanying figures and in which:

FIG. 1 illustrates a block diagram that shows a prior art relationship of a coal gasification step and a Fischer-Tropsch process step;

FIG. 2 illustrates a diagram of a typical prior art coal gasifier;

FIG. 3 illustrates a diagram of an apparatus for handling and conditioning hydrocarbon material to be provided to a hydrocarbon pyrolysis unit of the present invention;

FIG. 4 illustrates a diagram of a hydrocarbon pyrolysis unit of the present invention;

FIG. 5 illustrates a diagram of an apparatus and method for treating syngas in accordance with the present invention;

FIG. 6 illustrates a diagram of a method for converting syngas to gasoline, diesel, naphtha, etc. in accordance with the present invention;

FIG. 7 illustrates a horizontal arrangement of two plasma torches surrounding one plasma pyrolysis zone;

FIG. 8 illustrates a horizontal arrangement of three plasma torches surrounding one plasma pyrolysis zone;

FIG. 9 illustrates a horizontal arrangement of four plasma torches surrounding one plasma pyrolysis zone;

FIG. 10 illustrates a vertical arrangement of two plasma pyrolysis zones in vertical alignment;

FIG. 11 illustrates a vertical arrangement of three plasma pyrolysis zones in staggered alignment;

FIG. 12 illustrates a vertical arrangement of one plasma pyrolysis zone located above two plasma torches; and

FIG. 13 illustrates a vertical arrangement of one plasma pyrolysis zone located above a first set of two plasma torches and below a second set of two plasma torches.

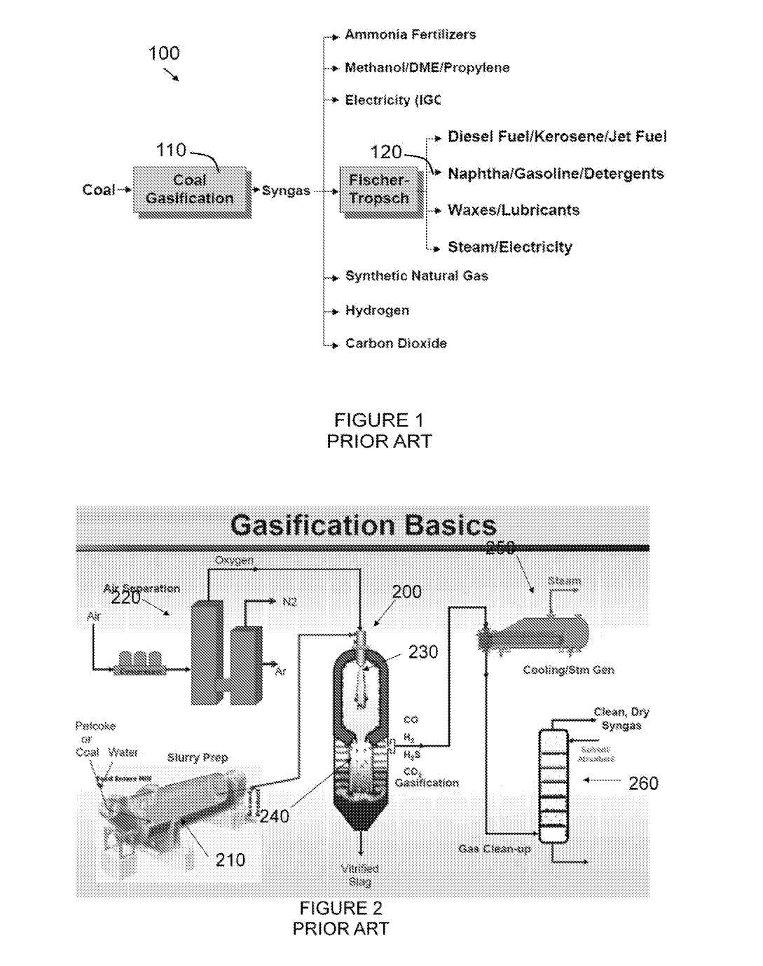

### DEFINITIONS

To facilitate the understanding of the present invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention.

The word “exemplary” is used herein to mean “serving as an example, instance, or illustration.” Any embodiment described herein as “exemplary” is not necessarily to be construed as preferred or advantageous over other embodiments. The words “pyrolysis zone” are used herein to mean “a region of a pyrolysis reaction that is created by an alignment of plasma torches that are configured to generate temperature, pressure, and momentum that increases the efficiency of the pyrolysis reaction within the region.”

### DETAILED DESCRIPTION

The detailed description set forth below is intended as a description of various embodiments of the present invention and is not intended to represent the only embodiments in which the present invention may be practiced. The detailed description includes specific details for the purpose of providing a thorough understanding of the present invention. However, it will be apparent to those skilled in the art that the present invention may be practiced without these specific details. In some instances, well known structures and components are shown in block diagram form in order to avoid obscuring the concepts of the present invention.

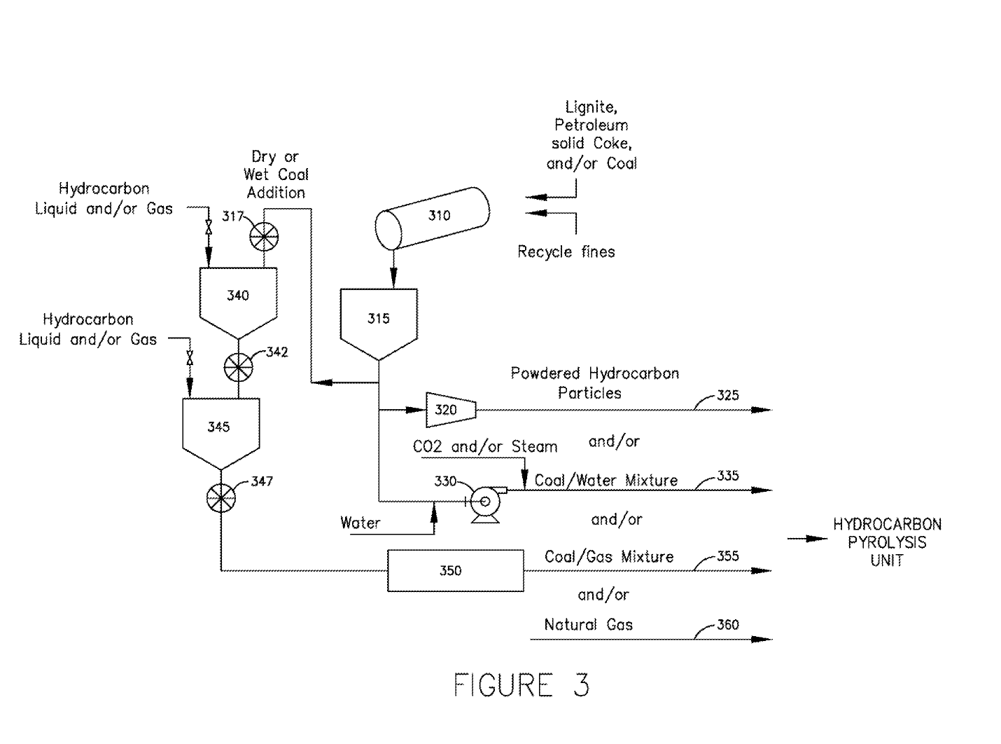

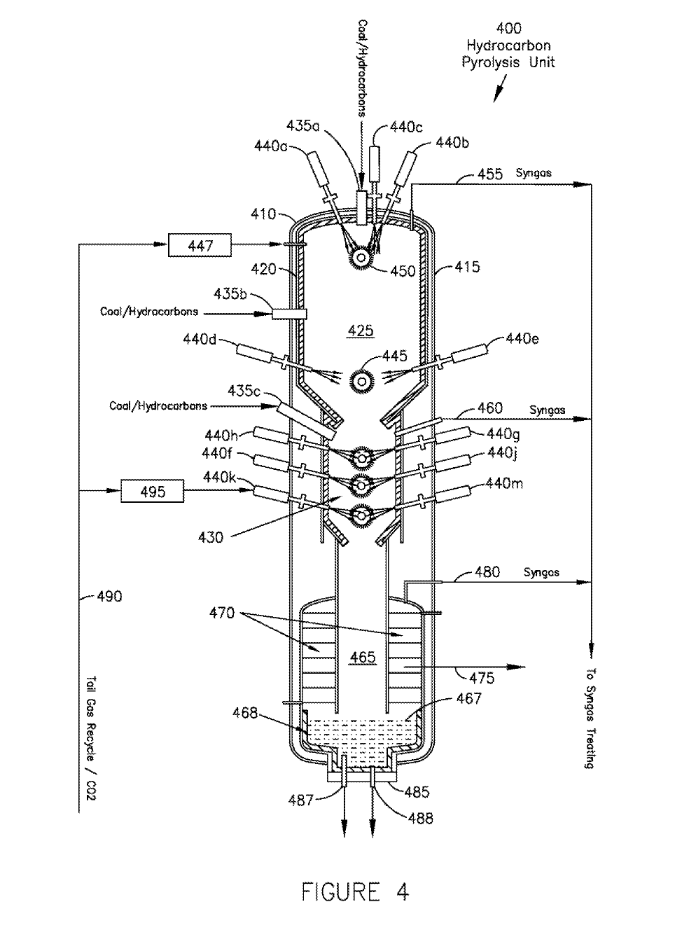

FIG. 3 illustrates a diagram of an apparatus for handling and conditioning hydrocarbon material to be provided to a hydrocarbon pyrolysis unit of the present invention. As shown in FIG. 3, hydrocarbon material (e.g., coal, lignite, petroleum solid coke) to be used to produce syngas is provided to a hydrocarbon delivery unit 310. The hydrocarbon delivery unit 310 provides the hydrocarbon material to a pulverizer unit 315. The pulverizer unit 315 breaks up the hydrocarbon material into very small particles that are in the form a fine powder. After the hydrocarbon material has been pulverized a pump/conveyor unit 320 delivers the powdered hydrocarbon particles to a pyrolysis reaction chamber in the hydrocarbon pyrolysis unit (shown in FIG. 4). This first input of hydrocarbon material to the hydrocarbon pyrolysis unit is indicated in FIG. 3 by arrow 325. The powdered hydrocarbon particles are subjected to very high heat in the hydrocarbon pyrolysis unit to break the chemical bonds that bind the carbon and hydrogen atoms of the hydrocarbon material.

The pulverized hydrocarbon material may be fed to the pyrolysis zone with water and carbon dioxide (CO₂) and/or steam. A pump/conveyor unit 330 delivers the mixture of the powdered hydrocarbon particles and other feed components into a pyrolysis reaction chamber in the hydrocarbon pyrolysis unit (shown in FIG. 4). This second input of hydrocarbon material to the hydrocarbon pyrolysis unit is indicated in FIG. 3 by arrow 335.

The pulverized hydrocarbon material may also be mixed with hydrocarbon liquids and/or gas. This step is also shown in FIG. 3. The pulverized hydrocarbon material from the pulverizer 315 is provided to a pressurization device 317. The output of pressurization device 317 is provided to a multi-pressure range mixer unit 340. Hydrocarbon gas at variable pressure (e.g., at 200 psi to 800 psi) is added to the multi-pressure range mixer unit 340 and mixed with the pulverized hydrocarbon material from the pulverizer 315. The output of the multi-pressure range mixer unit 340 is provided as input to a pressurization device 342. The output of pressurization device 342 is provided to a high pressure mixer unit 345. Hydrocarbon gas and/or liquid at high pressure (e.g., at 600 psi to 2000 psi) is added to the high pressure mixer unit 345 and mixed with the mixture of hydrocarbon material and hydrocarbon gas that has been received from the multi-pressure range mixer unit 340. The output of the high pressure mixer unit 345 is provided to a pressurization device 347. The output of the pressurization device 347 is provided to a solids/gas mixer unit 350 to provide additional mixing of the solid hydrocarbon material and gas and/or liquid hydrocarbon. The output of the solids/gas mixer unit 350 is provided to a pyrolysis chamber in the hydrocarbon pyrolysis unit (shown in FIG. 4). This third input of the mixture of solid hydrocarbon material and hydrocarbon gas and/or liquid to the hydrocarbon pyrolysis unit is indicated in FIG. 3 by arrow 355. Hydrocarbon material in the form of gas and/or liquid may also be provided directly to the pyrolysis unit. This fourth input of gas and/or liquid to the hydrocarbon pyrolysis unit is indicated in FIG. 3 by arrow 360.

FIG. 4 illustrates a diagram that shows a hydrocarbon pyrolysis unit 400 of the present invention. For brevity the hydrocarbon pyrolysis unit 400 will sometimes be referred to simply as the pyrolysis unit 400. The pyrolysis unit 400 operates using plasma heating devices. The pyrolysis unit 400 comprises a reactor vessel 410 that is refractory lined and/or equipped with a water jacket to withstand a bulk reactor temperature of up to 2,800 degrees Fahrenheit (2,800° F.). In alternative embodiments the reactor vessel 410 may be designed to withstand temperatures that are greater than 2,800 degrees Fahrenheit (2,800° F.).

The reactor vessel 410 comprises an outer membrane wall 415 that encloses the various parts of the reactor vessel 410. The membrane wall 415 may be provided with an external cooling source (not shown) to reduce the temperature of the reactor vessel 410. The membrane wall 415 may also be provided with an additional refractory lined vessel (not shown).

The reactor vessel 410 comprises structural walls 420 that form a pyrolysis reaction chamber 425 and a plasma pyrolysis chamber 430. Hydrocarbon material may be introduced into the pyrolysis reaction chamber 425 through one or more feed injectors 435. In FIG. 4 the individual feed injectors are designated with a letter following the reference numeral (e.g., 435a, 435b, etc.). As shown in FIG. 4, in one embodiment of the reactor vessel 410 a feed injector 435a provides the hydrocarbon material through the top of the pyrolysis reaction chamber 425. In another embodiment of the reactor vessel 410 a feed injector 435b provides the hydrocarbon material through a side of the pyrolysis reaction chamber 425. In another embodiment of the reactor vessel 410 a feed injector 435c provides the hydrocarbon material through a side of the plasma pyrolysis chamber 430. A plurality of feed injectors 435 may be used to provide hydrocarbon material to the pyrolysis reaction chamber 425 and to the plasma pyrolysis chamber 430.

Heat is generated within the reactor vessel 410 by one or more plasma torches 440. In FIG. 4 the individual plasma torches are designated with a letter following the reference numeral 440 (e.g., 440a, 440b, 440c, etc.). Plasma gases such as carbon dioxide (CO₂), steam (H₂O) and/or oxygen (O₂) are provided to each of the plasma torches 440 to operate the plasma torches 440. One or more plasma torches 440 provide heat to the pyrolysis reaction chamber 425. As shown in FIG. 4, in one embodiment the plasma torches 440 are located in the top of the pyrolysis reaction chamber 425. In another embodiment of the pyrolysis reactor vessel 410 one or more plasma torches 440 are located in a side of the pyrolysis reaction chamber 425. In another embodiment of the reactor vessel 410 one or more plasma torches 440 are located in both the top and the side of the pyrolysis reaction chamber 425. In another embodiment of the pyrolysis reactor vessel 410 one or more plasma torches 440 are located within the side of plasma pyrolysis chamber 430.

A plurality of plasma torches 440 may be placed at a variety of locations in the walls of the pyrolysis reaction chamber 425 and in the walls of the plasma pyrolysis chamber 430. Two or more plasma torches 440 may be located in the walls of the pyrolysis reaction chamber 425 (or in the walls of the plasma pyrolysis chamber 430) in order to preserve symmetry and provide a balance between the forces of the opposing plasma jets. For example, consider the two plasma torches (440d and 440e) that are located within the side walls of the pyrolysis reaction chamber 425. The circular area that is shown in FIG. 4 that is designated with reference numeral 445 represents a plasma pyrolysis zone where the plasma temperatures have a maximum value. The plasma pyrolysis zone 445 is created by an alignment of the plasma torches (440d and 440e) which are configured to generate the temperatures and pressures that are necessary to increase the efficiency of the pyrolysis reaction.

The arrows that point from the first plasma torch 440d on the left side of the pyrolysis reaction chamber 425 to the plasma pyrolysis zone 445 represent a jet of plasma that originates from the first plasma torch 440d and is directed toward the plasma pyrolysis zone 445. The arrows that point from the second plasma torch 440e on the right side of the pyrolysis reaction chamber 425 to the plasma pyrolysis zone 445 represent a jet of plasma that originates from the second plasma torch 440e and is directed toward the plasma pyrolysis zone 445. Similar circular areas in FIG. 4 represent similar plasma pyrolysis zones for the other plasma torches 440 that are located in the pyrolysis reaction chamber 425 or that are located in the plasma pyrolysis chamber 430. In addition, two or more plasma torches 440 may be located at an angle to each other in the top of the pyrolysis reaction chamber 425 (e.g., 440a, 440b, 440c). This arrangement is shown in FIG. 4 where the plasma pyrolysis zone is designated with reference numeral 450.

The operation of the plasma torches 440 will now be discussed in more detail. Matter is made up of molecules. Molecules comprise two or more atoms that are held together by atomic bonds. Atomic bonds have a certain amount of energy that provides the strength that holds the atoms together. This energy is referred to as bond energy. If the value of the energy between the two atoms exceeds the bond energy, then the bond between the two atoms will break and the atoms will separate.

The term “plasma” refers to a gas that has been heated beyond its ionization point. A plasma is an ionized gas at a high temperature that is capable of conducting electric current. A plasma torch is an apparatus that generates sufficient heat to increase gas temperatures up to very high levels that cannot be attained by conventional heaters. For example, plasma temperatures can reach levels that equal or exceed the temperature of the surface of the sun. As previously mentioned, the operating temperature in a typical plasma gasification reactor is between seven thousand two hundred degrees Fahrenheit (7,200° F.) and twelve thousand six hundred degrees Fahrenheit (12,600° F.).

Molecules that are exposed to high plasma temperatures are efficiently ionized and broken into individual atoms. The separated individual atoms can then be re-combined into simple compounds (e.g., carbon monoxide and hydrogen) when the temperature is subsequently lowered. The molecular bonds of any molecules that are exposed to high plasma temperatures will be broken. High plasma temperatures will dissociate all molecules of all types whether organic (carbon based) or inorganic.

The dissociation of molecules in the hydrocarbon material creates three separate components. These three components are (1) syngas, and (2) molten metals for subsequent recovery, and (3) inorganic “slag” materials. As previously mentioned, the syngas (which is composed primarily of carbon monoxide (CO) and hydrogen (H₂) is scrubbed to remove sulfur compounds (SO_{X}) and nitrogen compounds (NO_{X}) and halogens such as chlorine (Cl), fluorine (F) and bromine (Br). Plasma dissociation is carried out without additional air being added in order to produce carbon monoxide (CO) in the syngas and minimize the creation of carbon dioxide (CO₂). Steam can be optionally added to the pyrolysis reactor vessel 410 in order to promote the production of carbon monoxide (CO) and hydrogen (H₂).

Using plasma with a high initial temperature will allow the processing and destruction of carbon-carbon bonds and carbon-hydrogen bonds in the feed to be carried out at a greater rate and for a lower cost per ton than any other type of system. This may be accomplished by adiabatically compressing the plasma with magnets to create the higher desired temperature.

One plasma pinch torch apparatus is described in U.S. Pat. No. 7,446,289 issued to V. E. Staton et al. on Nov. 4, 2008. This plasma pinch torch apparatus comprises a device that adiabatically compresses a plasma stream and maintains the plasma stream in a compressed state. The plasma pinch torch apparatus employs a non-linear pinch by using a large number of relatively small coils arranged in a circle. The magnetic fields generated by the small coils are perpendicular to the arc direction. Higher temperatures are achieved by adding coils to the end of the tube, which allows the beam to be squeezed tighter. Larger beam diameters can be created by expanding the coil configuration. The plasma pinch torch apparatus creates extremely high temperatures with increased beam volume with almost proportional power increases. The plasma temperature can be controlled between an estimated twenty thousand degrees Kelvin (20,000° K) and one million degrees Kelvin (1,000,000° K). This is just one example of a plasma pinch torch apparatus. It is understood that this or other types of plasma torches may be used to carry out the method of the present invention.

The plasma torch apparatus is protected by thermal barriers and/or heat exchangers which provide thermal insulation between the plasma and heat sensitive components such as magnets. Additional thermal insulation and/or thermal exchangers are provided around the plasma torches to limit the temperature of the magnets and other plasma torch elements.

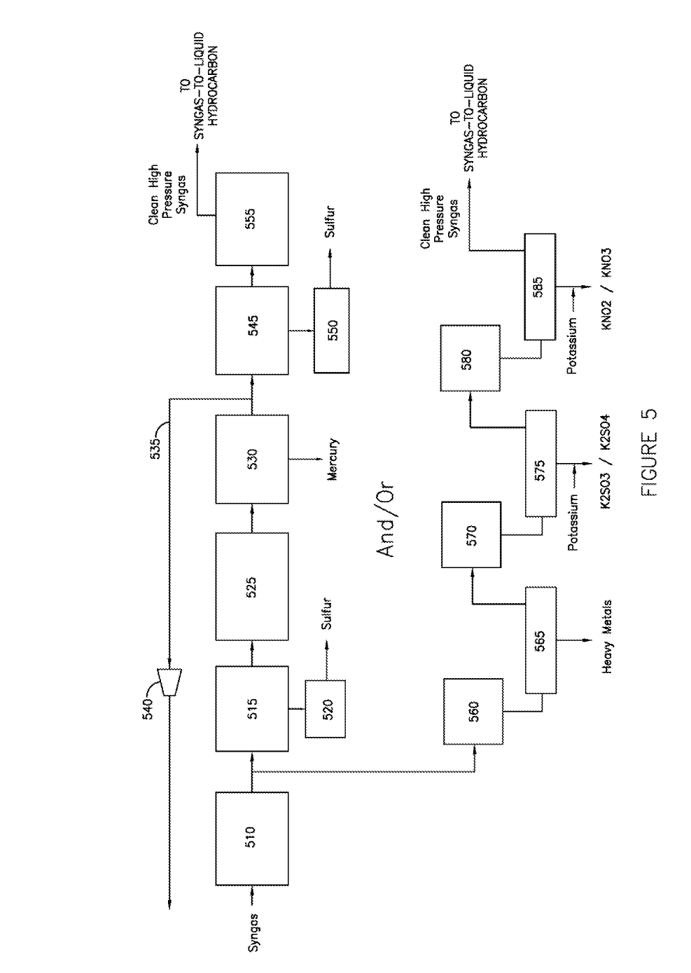

The syngas that is produced in the pyrolysis reaction chamber 425 and in the plasma pyrolysis chamber 430 is extracted as shown in FIG. 4. Syngas that is produced within the pyrolysis reaction chamber 425 is extracted through conduit 455. Syngas that is present within the plasma pyrolysis chamber 430 is extracted through conduit 460. The residue from heating the powdered hydrocarbon particles within the pyrolysis reaction chamber 425 and within the plasma pyrolysis chamber 430 drops into a pyrolysis reaction quench section 465. The residue and molten ash in the pyrolysis reaction quench section 465 are cooled in an optional heat exchanger 470. As indicated by arrow 475 heat is recovered from the heat exchanger 470. Syngas that is present in the pyrolysis reaction quench section 465 is extracted through conduit 480. Syngas from conduits 455, 460 and 480 are subsequently treated using the steps that are shown in FIG. 5. Metals and other inorganic materials settle in a molten bath 467. The molten bath 467 is subjected to resistive heating 468. The metals and other inorganic materials and the molten glass are subsequently removed through conduits 487 and 488 in the bottom 485 of the pyrolysis unit 400. Conduit 487 removes high density metals and other inorganic compounds from the bottom of the molten bath 467.

As shown in FIG. 4, a tail gas recovery conduit 490 recycles a portion of the subsequently treated syngas back to the gas supply 447. Gas supply 447 provides carbon dioxide, high pressure hot water and/or high pressure steam to pyrolysis reaction chamber 425. Conduit 490 also recycles a portion of the subsequently treated syngas back to the plasma torches 440 to be used as a plasma burner gas. This is indicated in FIG. 4 by the connection of conduit 490 to a plasma gas unit 440k. Although plasma gas supply 495 is shown connected to conduit 490 and to only one plasma torch (i.e., 440k) in FIG. 4, it is understood that the plasma gas supply 495 is also connected to the other plasma torches 440 through other conduits (not shown in FIG. 4). Plasma gas supply 495 can provide carbon dioxide, water, oxygen and inert gases to plasma torches 440. Plasma gas supply 495 is not limited to provide identical gas supply to each plasma torch 440.

FIG. 5 illustrates a diagram of an apparatus and method for treating syngas in accordance with the present invention. The syngas that is obtained from the pyrolysis unit 400 that is shown in FIG. 4 is provided to a cyclone, cooling and filter unit 510. After the syngas leaves the cyclone, cooling and filter unit 510 it may be sent to one of two different treatment paths. In the first treatment path the syngas is sent to a scrubber unit 515. The scrubber unit 515 removes sulfur from the syngas using a sour water stripper unit 520. The syngas is then sent to a treatment unit 525 that provides cooling, Boiler Feed Water (BFW), heating, knockout and carbonyl sulfide (COS) hydrolysis treatment. The syngas is then sent to mercury removal unit 530 that removes mercury from the syngas.

A first portion of the syngas that comes out of the mercury removal unit 530 is recycled back to the pyrolysis unit 400 through conduit 535. Recycle compressor 540 moves the recycled syngas through conduit 535. Conduit 535 of FIG. 5 connects to conduit 490 of FIG. 4. A second portion of the syngas that comes out of the mercury removal unit 530 is sent to a hydrogen sulfide removal unit 545. The hydrogen sulfide removal unit 545 removes hydrogen sulfide (H₂S) from the syngas. A sulfur handling unit 550 subsequently converts the H₂S to liquid sulfur for removal from the process. The syngas from the hydrogen sulfide removal unit 545 is sent to a zinc oxide (ZnO) polishing unit 555. The syngas that emerges from the zinc oxide (ZnO) polishing unit 555 is clean high pressure syngas.

In the second treatment path after the cyclone, cooling and filter unit 510 the syngas is sent to a scrubber. For example, the scrubber may be a Free-Jet Collision Scrubber of the type described in U.S. Patent Application Publication No. 2008/0250715. Other types of scrubbers may also be used. The scrubber removes heavy metals from the syngas using a metal reactor system 560. An aero-coalescer unit 565 extracts the heavy metals from the syngas and sends the syngas to a sulfur reactor system 570 that removes sulfur from the syngas. An aero-coalescer unit 575 extracts the sulfur from the syngas and sends the syngas to a nitrogen reactor system 580 that removes nitrogen from the syngas. An aero-coalescer 585 extracts nitrogen from the syngas. The syngas that emerges from the aero-coalescer 585 is clean high pressure syngas.

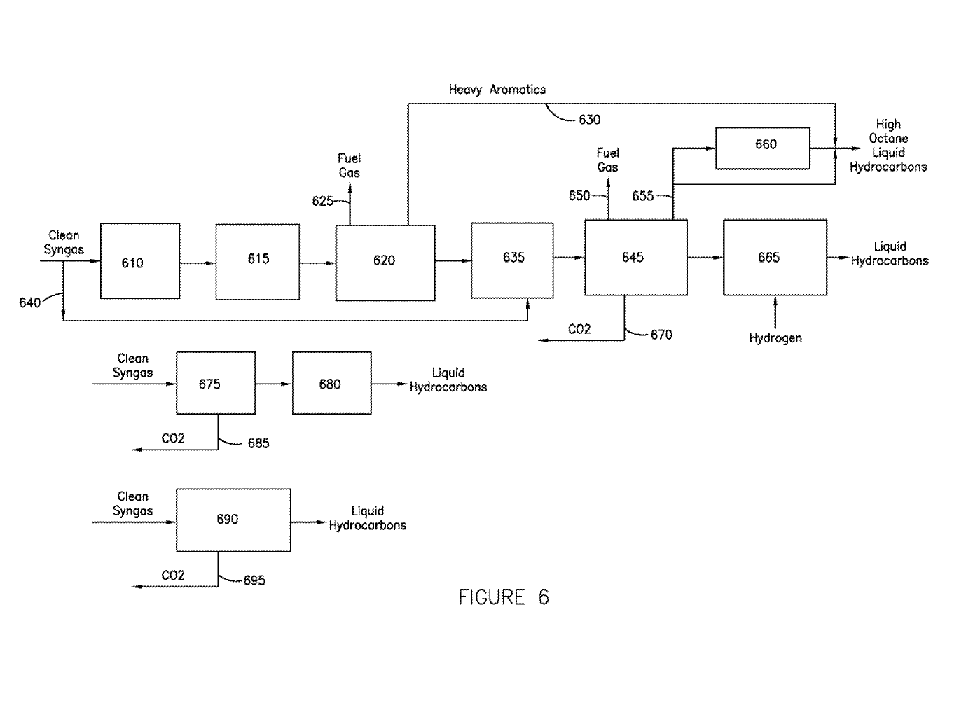

FIG. 6 illustrates a diagram of a method for converting syngas to gasoline and diesel in accordance with the present invention. Clean high pressure syngas from zinc oxide (ZnO) polishing unit 555 (or from the aero-coalescer 585) is provided to a methanol synthesis unit 610. The methanol synthesis unit 610 coverts the syngas to methanol. The methanol from the methanol synthesis unit 610 is provided to a methanol to olefins unit 615. The methanol to olefins unit 615 coverts the methanol to olefins and provides the olefins to a fractionation and compression unit 620. The fractionation and compression unit 620 provides fuel gas on conduit 625 and heavy aromatics on conduit 630. The fractionation and compression unit 620 also provides olefins to olefins to gasoline and distillate unit 635. As shown in FIG. 6, the clean high pressure syngas from zinc oxide (ZnO) polishing unit 555 (or from the aero-coalescer 585) can be provided directly to the olefins to gasoline and distillate unit 635 through conduit 640.

The output of the olefins to gasoline and distillate unit 635 is provided to a fractionation unit 645. The fractionation unit 645 provides fuel gas on conduit 650 and gasoline on conduit 655. The gasoline on conduit 655 may optionally be supplied to an alkylation unit 660. The fractionation unit 645 also provides distillate to a distillate hydrotreater unit 665. The distillate hydrotreater unit 665 adds hydrogen to the distillate to form liquid hydrocarbons fuel. Carbon dioxide (CO₂) enters conduit 670 from fractionation unit 645. Conduit 670 of FIG. 6 connects to conduit 490 of FIG. 4.

In the second syngas-to-liquid hydrocarbons path, clean syngas enters a Fischer-Tropsch (F-T) reactor 675. Fischer-Tropsch (F-T) liquids from the Fischer-Tropsch (F-T) reactor 675 enter product upgrading units 680 to form liquid hydrocarbons fuel. Carbon dioxide (CO₂) enters conduit 685 from the Fischer-Tropsch (F-T) reactor 675. Conduit 685 of FIG. 6 connects to conduit 490 of FIG. 4.

In the third syngas-to-liquid hydrocarbons path, clean syngas enters an equivalent syngas-to-diesel system 690. Examples of such systems include methanol-to-olefins (MTO) by UOP, L.L.C., Mobile Olefins-to-Gasoline Distillate (MOGD) by Exxon Mobil, and MTSynfuels by Lurgi, etc. and combinations thereof. Carbon dioxide (CO₂) enters conduit 695 from equivalent syngas-to-liquid hydrocarbons system 690. Conduit 695 of FIG. 6 connects to conduit 490 of FIG. 4.

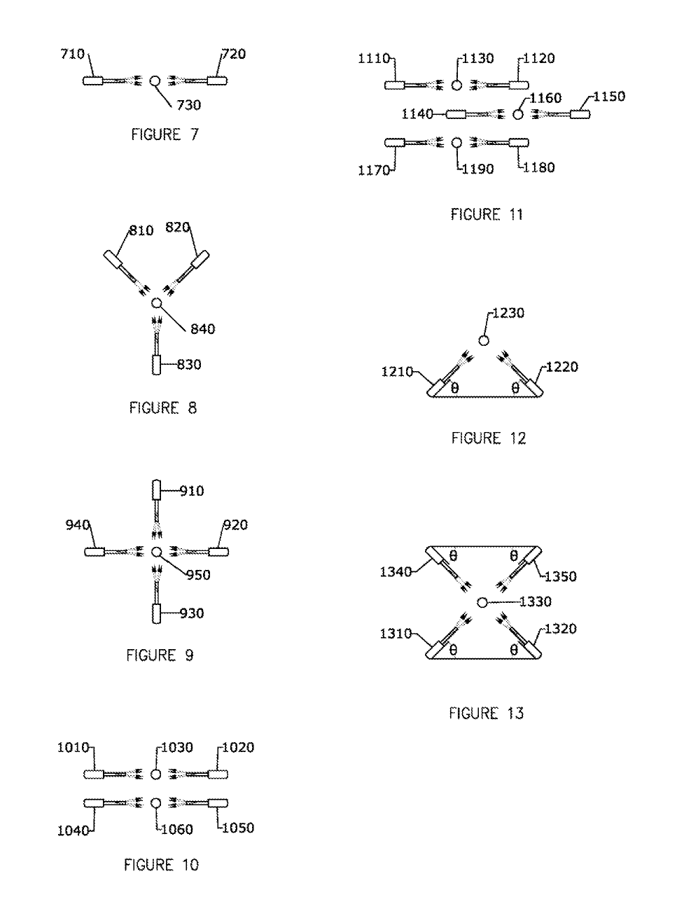

FIG. 7 illustrates a horizontal arrangement of two plasma torches that surround one plasma pyrolysis zone. FIG. 7 is a top view showing the horizontal placement of a first plasma torch 710 and a second plasma torch 720 within the plasma reaction chamber 425 (not shown in FIG. 7) or within the plasma pyrolysis chamber 430 (not shown in FIG. 7) of the pyrolysis unit 400. The circular area in FIG. 7 that is designated with reference numeral 730 represents a plasma pyrolysis zone where the plasma temperatures have a maximum value. The arrow that points from the first plasma torch 710 to the plasma pyrolysis zone 730 represents a jet of plasma that originates from the first plasma torch 710 and is directed toward the plasma pyrolysis zone 730. The arrow that points from the second plasma torch 720 to the plasma pyrolysis zone 730 represents a jet of plasma that originates from the second plasma torch 720 and is directed toward the plasma pyrolysis zone 730. The two plasma torches (710, 720) are placed on directly opposite sides of the plasma pyrolysis zone 730 in order to preserve symmetry and provide a balance between the forces of the opposing plasma jets. The two plasma torches (710, 720) are placed so that each plasma torch is located at an angle of one hundred eighty degrees (180°) with respect to the other plasma torch. It is understood that the two plasma torches may be aligned with respect to each other at angle that is other than one hundred eighty degrees (180°).

FIG. 8 illustrates a horizontal arrangement of three plasma torches that surround one plasma pyrolysis zone. FIG. 8 is a top view showing the horizontal placement of a first plasma torch 810 and a second plasma torch 820 and a third plasma torch 830 within the plasma reaction chamber 425 (not shown in FIG. 8) or within the plasma pyrolysis chamber 430 (not shown in FIG. 8) of the pyrolysis unit 400. The circular area in FIG. 8 that is designated with reference numeral 840 represents a plasma pyrolysis zone where the plasma temperatures have a maximum value. The arrow that points from the first plasma torch 810 to the plasma pyrolysis zone 840 represents a jet of plasma that originates from the first plasma torch 810 and is directed toward the plasma pyrolysis zone 840. The arrow that points from the second plasma torch 820 to the plasma pyrolysis zone 840 represents a jet of plasma that originates from the second plasma torch 820 and is directed toward the plasma pyrolysis zone 840. The three plasma torches (810, 820, 830) are placed so that each plasma torch is located at an angle of one hundred twenty degrees (120°) with respect to each of the other two plasma torches. This positioning with respect to the plasma pyrolysis zone 840 is designed to preserve symmetry and provide a balance between the forces of the opposing plasma jets. It is understood that the three plasma torches may be aligned with respect to each other at angle that is other than one hundred twenty degrees (120°).

FIG. 9 illustrates a horizontal arrangement of four plasma torches that surround one plasma pyrolysis zone. FIG. 9 is a top view showing the horizontal placement of a first plasma torch 910 and a second plasma torch 920 and a third plasma torch 930 and a fourth plasma torch 940 within the plasma reaction chamber 425 (not shown in FIG. 9) or within the plasma pyrolysis chamber 430 (not shown in FIG. 9) of the pyrolysis unit 400. The circular area in FIG. 9 that is designated with reference numeral 950 represents a plasma pyrolysis zone where the plasma temperatures have a maximum value. The arrow that points from the first plasma torch 910 to the plasma pyrolysis zone 950 represents a jet of plasma that originates from the first plasma torch 910 and is directed toward the plasma pyrolysis zone 950. The arrow that points from the second plasma torch 920 to the plasma pyrolysis zone 950 represents a jet of plasma that originates from the second plasma torch 920 and is directed toward the plasma pyrolysis zone 950. The four plasma torches (910, 920, 930, 940) are placed so that each plasma torch is located at an angle of ninety degrees (90°) with respect to each of the other two adjacent plasma torches. This positioning with respect to the plasma pyrolysis zone 950 is designed to preserve symmetry and provide a balance between the forces of the opposing plasma jets. It is understood that the four plasma torches may be aligned with respect to each other at angle that is other than ninety degrees (90°).

FIG. 10 illustrates a vertical arrangement of two plasma pyrolysis zones in a vertical alignment. FIG. 10 is a side view showing the placement of a first plasma torch 1010 and a second plasma torch 1020 within a first level of the plasma reaction chamber 425 (not shown in FIG. 10) or within a first level of the plasma pyrolysis chamber 430 (not shown in FIG. 10) of the pyrolysis unit 400. The first circular area in FIG. 10 that is designated with reference numeral 1030 represents a plasma pyrolysis zone where the plasma temperatures in the first level have a maximum value. The arrow that points from the first plasma torch 1010 to the plasma pyrolysis zone 1030 represents a jet of plasma that originates from the first plasma torch 1010 and is directed toward the plasma pyrolysis zone 1030. The arrow that points from the second plasma torch 1020 to the plasma pyrolysis zone 1030 represents a jet of plasma that originates from the second plasma torch 1020 and is directed toward the plasma pyrolysis zone 1030. In one advantageous embodiment, the two first level plasma torches (1010, 1020) are placed on directly opposite sides of the plasma pyrolysis zone 1030 in order to preserve symmetry and provide a balance between the forces of the opposing plasma jets.

FIG. 10 also illustrates a side view showing the placement of a third plasma torch 1040 and a fourth plasma torch 1050 within a second level of the plasma reaction chamber 425 (not shown in FIG. 10) or within a second level of the plasma pyrolysis chamber 430 (not shown in FIG. 10) of the pyrolysis unit 400. The second circular area in FIG. 10 that is designated with reference numeral 1060 represents a plasma pyrolysis zone where the plasma temperatures in the second level have a maximum value. The arrow that points from the third plasma torch 1040 to the plasma pyrolysis zone 1060 represents a jet of plasma that originates from the third plasma torch 1040 and is directed toward the plasma pyrolysis zone 1060. The arrow that points from the fourth plasma torch 1050 to the plasma pyrolysis zone 1060 represents a jet of plasma that originates from the fourth plasma torch 1050 and is directed toward the plasma pyrolysis zone 1060. In one advantageous embodiment, the two second level plasma torches (1040, 1050) are placed on directly opposite sides of the plasma pyrolysis zone 1060 in order to preserve symmetry and provide a balance between the forces of the opposing plasma jets. The second level plasma torches (1040, 1050) and the plasma pyrolysis zone 1060 are located in the plasma reaction chamber 425 (or in the plasma pyrolysis chamber 430) below the first level plasma torches (1010, 1020) and the plasma pyrolysis zone 1030. The operation of the second level plasma torches (1040, 1050) heats and dissociates any hydrocarbon particles that have passed through the first level plasma torches (1010, 1020) without being dissociated.

The example given above in FIG. 10 shows the use of two plasma torches in each of the two levels. It is understood, however, that the invention is not limited to the use of two plasma torches in each of the two levels. More than two plasma torches may be used. For example, the three plasma torches (810, 820, 830) that are shown in FIG. 8 may be used in one or both of the two levels. In addition, the four plasma torches (910, 920, 930, 940) that are shown in FIG. 9 may be used in one or both of the two levels. Other combinations and additional levels are also possible. It is also understood that the invention is not limited to the use of only two levels and that additional levels can be utilized. More than two levels of plasma torches may also be employed.

FIG. 11 illustrates a vertical arrangement of three plasma pyrolysis zones in a staggered alignment. The two plasma pyrolysis zones (1030, 1060) that are shown in FIG. 10 are vertically aligned so that the second plasma pyrolysis zone 1060 is located directly below the first plasma pyrolysis zone 1030. FIG. 11 shows that more than two plasma pyrolysis zones may be used and that they need not be vertically aligned.

FIG. 11 illustrates a side view showing the placement of a first plasma torch 1110 and a second plasma torch 1120 within a first level of the plasma reaction chamber 425 (not shown in FIG. 11) or within the plasma pyrolysis chamber 430 (not shown in FIG. 11) of the pyrolysis unit 400. The first circular area in FIG. 11 that is designated with reference numeral 1130 represents a first plasma pyrolysis zone where the plasma temperatures in the first level have a maximum value. The arrow that points from the first plasma torch 1110 to the first plasma pyrolysis zone 1130 represents a jet of plasma that originates from the first plasma torch 1110 and is directed toward the first plasma pyrolysis zone 1130. The arrow that points from the second plasma torch 1120 to the first plasma pyrolysis zone 1130 represents a jet of plasma that originates from the second plasma torch 1120 and is directed toward the first plasma pyrolysis zone 1130. In one advantageous embodiment, the two first level plasma torches (1110, 1120) are placed on directly opposite sides of the first plasma pyrolysis zone 1130 in order to preserve symmetry and provide a balance between the forces of the opposing plasma jets.

The second level plasma torches (1140, 1150) and the second plasma pyrolysis zone 1160 operate in the same manner as the first level plasma torches (1110, 1120) and the first plasma pyrolysis zone 1130. The second level plasma torches (1140, 1150) and the second plasma pyrolysis zone 1160 are located in the plasma reaction chamber 425 (or in the plasma pyrolysis chamber 430) below the first level plasma torches (1110, 1120) and the first plasma pyrolysis zone 1130. The operation of the second level plasma torches (1140, 1150) heats and dissociates any hydrocarbon particles that have passed through the first level plasma torches (1110, 1120) without being dissociated.

Similarly, the third level plasma torches (1170, 1180) and the third plasma pyrolysis zone 1190 operate in the same manner as the first level plasma torches (1110, 1120) and the first plasma pyrolysis zone 1130. The third level plasma torches (1170, 1180) and the third plasma pyrolysis zone 1190 are located in the plasma reaction chamber 425 (or in the plasma pyrolysis chamber 430) below the second level plasma torches (1140, 1150) and the second plasma pyrolysis zone 1160. The operation of the third level plasma torches (1170, 1180) heats and dissociates any hydrocarbon particles that have passed through the second level plasma torches (1140, 1150) without being dissociated.

The example given above in FIG. 11 shows the use of two plasma torches in each of the three levels. It is understood, however, that the invention is not limited to the use of two plasma torches in each of the three levels. More than two plasma torches may be used. For example, the three plasma torches (810, 820, 830) that are shown in FIG. 8 may be used in one, both, or all three levels. In addition, the four plasma torches (910, 920, 930, 940) that are shown in FIG. 9 may be used in one, both, or all three levels. Other combinations are also possible. It is also understood that the invention is not limited to the use of only three levels. More than three levels of plasma torches may also be employed.

FIG. 12 illustrates a vertical arrangement of one plasma pyrolysis zone located above two plasma torches. FIG. 12 is a side view showing the placement of a first plasma torch 1210 and a second plasma torch 1220 within a level of the plasma reaction chamber 425 (not shown in FIG. 12) or within the plasma pyrolysis chamber 430 (not shown in FIG. 12) of the pyrolysis unit 400. The circular area in FIG. 12 that is designated with reference numeral 1230 represents a plasma pyrolysis zone where the plasma temperatures have a maximum value. The arrow that points from the first plasma torch 1210 to the plasma pyrolysis zone 1230 represents a jet of plasma that originates from the first plasma torch 1210 and is directed toward the plasma pyrolysis zone 1230. The arrow that points from the second plasma torch 1220 to the plasma pyrolysis zone 1230 represents a jet of plasma that originates from the second plasma torch 1220 and is directed toward the plasma pyrolysis zone 1230. In one advantageous embodiment, the two plasma torches (1210, 1220) are placed on directly opposite sides of the plasma pyrolysis zone 1230 in order to preserve symmetry and provide a balance between the horizontal components of the forces of the opposing plasma jets.

As shown in FIG. 12, the first plasma torch 1210 is inclined at an angle (designated θ) with respect to a horizontal plane through the plasma reaction chamber 425 (not shown in FIG. 12) or the plasma pyrolysis chamber 430 (not shown in FIG. 12) of pyrolysis unit 400. Similarly, the second plasma torch 1220 is also inclined at an angle (designated θ) with respect to the same horizontal plane. In one advantageous embodiment of the invention the value of the angle θ is thirty degrees (30°). As previously mentioned, the horizontal components of the forces of the opposing plasma jets are balanced. But the vertical components of the forces of the opposing plasma jets are not balanced. The plasma jets exert a net vertical force on the hydrocarbon particles that are within the plasma reaction chamber 425 or within the plasma pyrolysis chamber 430. The net vertical force keeps the hydrocarbon particles suspended within the plasma reaction chamber 425 (or within the plasma pyrolysis chamber 430) longer than they would be suspended if there were no net vertical force. The longer time of suspension for the hydrocarbon particles means that there is an increased probability that more of the hydrocarbon particles will be dissociated than would otherwise be the case.

FIG. 13 illustrates a vertical arrangement of one plasma pyrolysis zone located above a first set of two plasma torches and below a second set of two plasma torches. FIG. 13 is a side view showing the placement of a first plasma torch 1310 and a second plasma torch 1320 within a first level of the plasma reaction chamber 425 (not shown in FIG. 13) or within a first level of the plasma pyrolysis chamber 430 (not shown in FIG. 13) of the pyrolysis unit 400. The circular area in FIG. 13 that is designated with reference numeral 1330 represents a plasma pyrolysis zone where the plasma temperatures have a maximum value. The arrow that points from the first plasma torch 1310 to the plasma pyrolysis zone 1330 represents a jet of plasma that originates from the first plasma torch 1310 and is directed toward the plasma pyrolysis zone 1330. The arrow that points from the second plasma torch 1320 to the plasma pyrolysis zone 1330 represents a jet of plasma that originates from the second plasma torch 1320 and is directed toward the plasma pyrolysis zone 1330. In one advantageous embodiment, the two plasma torches (1310, 1320) are placed on directly opposite sides of the plasma pyrolysis zone 1330 in order to preserve symmetry and provide a balance between the horizontal components of the forces of the opposing plasma jets.

As shown in FIG. 13, the first plasma torch 1310 is inclined at an angle (designated θ) with respect to a horizontal plane through the plasma reaction chamber 425 (not shown in FIG. 13) or the plasma pyrolysis chamber 430 (not shown in FIG. 13) of the pyrolysis unit 400. Similarly, the second plasma torch 1320 is also inclined at an angle (designated θ) with respect to the same horizontal plane. In one advantageous embodiment of the invention the value of the angle θ is thirty degrees (30°). Other values of the angle θ are also possible.

FIG. 13 is a side view that also shows the placement of a third plasma torch 1340 and a fourth plasma torch 1350 within a second level of the plasma reaction chamber 425 (not shown in FIG. 13) or within the plasma pyrolysis chamber 430 (not shown in FIG. 13) of the pyrolysis unit 400. The arrow that points from the third plasma torch 1340 to the plasma pyrolysis zone 1330 represents a jet of plasma that originates from the third plasma torch 1340 and is directed toward the plasma pyrolysis zone 1330. The arrow that points from the fourth plasma torch 1350 to the plasma pyrolysis zone 1330 represents a jet of plasma that originates from the fourth plasma torch 1350 and is directed toward the plasma pyrolysis zone 1330. In one advantageous embodiment, the two plasma torches (1340, 1350) are placed on directly opposite sides of the plasma pyrolysis zone 1330 in order to preserve symmetry and provide a balance between the horizontal components of the forces of the opposing plasma jets.

As also shown in FIG. 13, the third plasma torch 1340 is inclined at a downward angle (designated θ) with respect to a horizontal plane through the plasma reaction chamber 425 (not shown in FIG. 13) or the plasma pyrolysis chamber 430 (not shown in FIG. 13) of the pyrolysis unit 400. Similarly, the fourth plasma torch 1350 is also inclined at a downward angle (designated θ) with respect to the same horizontal plane. In one advantageous embodiment of the invention the value of the angle θ is thirty degrees (30°). Other values of the angle θ are also possible.

The horizontal components of the forces of the opposing plasma jets from the first plasma torch 1310 and the second plasma torch 1320 are balanced. The horizontal components of the forces of the opposing plasma jets from the third plasma torch 1340 and the fourth plasma torch 1350 are also balanced. The vertical components of the forces of the opposing plasma jets from the first plasma torch 1310 and the third plasma torch 1340 are balanced. The vertical components of the forces of the opposing plasma jets from the second plasma torch 1320 and the fourth plasma torch 1350 are also balanced.

In one advantageous embodiment, the value of the angle in FIG. 13 (designated θ) at which first plasma torch 1310 and second plasma torch 1320 are inclined upwardly with respect to a horizontal plane is equal to the value of the angle in FIG. 13 (also designated θ) at which the third plasma torch 1340 and the fourth plasma torch 1350 are inclined downwardly with respect to a horizontal plane. It is understood that in other embodiments of the present invention the values of the four angles that are shown in FIG. 13 may not be equal in value.

The hydrocarbon pyrolysis unit 400 of the present invention comprises a plurality of plasma torches 440 arranged in one or more of the configurations that have been previously mentioned. The operation of the plurality of plasma torches 440 in the various arrangements that have been described create in each instance a pyrolysis zone that increases the efficiency of the hydrocarbon pyrolysis unit 400 in breaking atomic bonds (including carbon-carbon bonds) of the hydrocarbon material that is located within the hydrocarbon pyrolysis unit 400 during a plasma pyrolysis process.

For example, consider the operation of the first plasma torch 1010 and the second plasma torch 1020 and the third plasma torch 1040 and the fourth plasma torch 1020 that are shown in FIG. 10. The operation of the first level of plasma torches (1010 and 1020) heats and dissociates hydrocarbon particles within the plasma pyrolysis zone 1030. The operation of the second level of plasma torches (1040 and 1050) heats and dissociates any hydrocarbon particles that have passed through the first level plasma torches (1010 and 1020) without being dissociated. The location and arrangement of the four plasma torches (1010, 1020, 1040, 1050) create a pyrolysis zone that increases the efficiency of the hydrocarbon pyrolysis unit 400 in breaking atomic bonds of hydrocarbon material. The hydrocarbon material in the hydrocarbon pyrolysis unit 400 is subjected to additional pyrolysis due to the presence and orientation of the additional plasma torches (1040 and 1050) in the second level.

Consider the operation of the six plasma torches that are shown in FIG. 11. The location and arrangement of the six plasma torches (1110, 1120, 1140, 1150, 1170, 1180) create a pyrolysis zone that increases the efficiency of the hydrocarbon pyrolysis unit 400 in breaking atomic bonds (including carbon-carbon bonds) of the hydrocarbon material. The hydrocarbon material in the hydrocarbon pyrolysis unit 400 is subjected to additional pyrolysis due to the presence and orientation of the additional plasma torches (1140 and 1150) in the second level and the presence and orientation of the additional plasma torches (1170 and 1180) in the third level.

The location and arrangement of the first plasma torch 1210 and the second plasma torch 1220 that are shown in FIG. 12 unit create a pyrolysis zone that increases an amount of time that the hydrocarbon material is present within the hydrocarbon pyrolysis unit 400. As previously mentioned, the vertical components of the forces of the opposing plasma jets of the two plasma torches (1210 and 1220) are not balanced. The plasma jets exert a net vertical force on the hydrocarbon particles that are within the hydrocarbon pyrolysis unit 400. The net vertical force keeps the hydrocarbon particles suspended longer than they would be suspended if there were no net vertical force. The longer time of suspension for the hydrocarbon particles means that there is an increased probability that more of the hydrocarbon particles will be dissociated than would otherwise be the case. The added time of suspension increases the efficiency of the hydrocarbon pyrolysis unit 400 in breaking the atomic bonds (including carbon-carbon bonds) of the hydrocarbon material.

The arrangement and operation of the plurality of plasma torches 440 within the hydrocarbon pyrolysis unit 400 creates a pyrolysis zone that generates a temperature that exceeds four thousand degrees Celsius (4,000° C.). This temperature is sufficient to create syngas that contains a significantly reduced level of contaminants (generally referred to as “clean” syngas). The clean syngas so produced does not require additional processing before it is sent downstream to currently existing syngas-to-fuel technologies. The clean syngas so produced also significantly reduces (or even eliminates) the need to use an air separator unit (ASU) in a downstream syngas-to-fuel processing facility. Reducing or eliminating the need to use an air separator unit (ASU) significantly reduces the capital cost in a syngas-to-fuel facility and reduces the number of processor units that are required to produce fuel from syngas.

The arrangement and operation of the plurality of plasma torches 440 within the hydrocarbon pyrolysis unit 400 may be adjustably selected and operated to create a pyrolysis zone that creates syngas that has a desired value of pressure and desired value of temperature within a range of values of pressure and temperature. The hydrocarbon pyrolysis unit 400 of the present invention is able to provide syngas having a range of values of pressures and temperatures. This means that the syngas that is created by the hydrocarbon pyrolysis unit 400 of the present invention can exactly meet the input requirements of downstream existing syngas-to-fuel technologies. This means that the hydrocarbon pyrolysis unit 400 of the present invention eliminates the need for a downstream syngas-to-fuel technology to use auxiliary equipment (such as an expensive compressor) to increase the pressure and temperature of the syngas to cause the syngas to meet the input pressure and temperature requirements of the downstream technology.

The arrangement and operation of the plurality of plasma torches 440 within the hydrocarbon pyrolysis unit 400 may be adjustably selected and operated to create a pyrolysis zone that creates syngas that has a value of pressure and a value of temperature that enables the syngas to be used as a plasma burner gas for the hydrocarbon pyrolysis unit 400. As previously mentioned, conduit 490 recycles a portion of the syngas back to the plasma torches 440 to be used as a plasma burner gas. Conduit 490 may also recycle a portion of the syngas back to the pyrolysis reaction chamber 425 of the hydrocarbon pyrolysis unit 400 to be used as a feedstock.

As previously mentioned, the arrangement and operation of the plurality of plasma torches 440 within the hydrocarbon pyrolysis unit 400 creates a pyrolysis zone that generates a temperature that exceeds four thousand degrees Celsius (4,000° C.). This temperature is sufficient to dissociate the atomic bonds of various undesirable chemicals. For example, water that is contaminated with undesirable biological chemicals (such as endocrines) may be purified by subjecting the contaminated water to a pyrolysis process in the hydrocarbon pyrolysis unit 400. The high temperatures that are created within the pyrolysis zone completely disrupt and destroy the undesirable biological chemicals in the water.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention.

All publications and patent applications mentioned in the specification are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or items, such as BB, AAA, MB, BBC, AAABCCCC, CBBAAA, CABABB, and so forth. The skilled artisan will understand that typically there is no limit on the number of item or items in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention.

1. A hydrocarbon pyrolysis unit comprising:
a plurality of plasma torches that are located within the hydrocarbon pyrolysis unit in an arrangement that causes an operation of the plurality of plasma torches to create a pyrolysis zone that increases an efficiency of the hydrocarbon pyrolysis unit in breaking atomic bonds of hydrocarbon material that is located within the hydrocarbon pyrolysis unit during a plasma pyrolysis process.

2. The hydrocarbon pyrolysis unit as set forth in claim 1, wherein the arrangement of the plurality of plasma torches within the hydrocarbon pyrolysis unit increases an amount of time that hydrocarbon material is present within the hydrocarbon pyrolysis unit during a plasma pyrolysis process.

3. The hydrocarbon pyrolysis unit as set forth in claim 1, wherein the arrangement of the plurality of plasma torches within the hydrocarbon pyrolysis unit increases an amount of time that hydrocarbon material is present within the pyrolysis zone.

4. The hydrocarbon pyrolysis unit as set forth in claim 1, wherein the pyrolysis zone increases an efficiency of the hydrocarbon pyrolysis unit in breaking carbon-carbon bonds of hydrocarbon material that is located within the hydrocarbon pyrolysis unit during a plasma pyrolysis process.

5. The hydrocarbon pyrolysis unit as set forth in claim 1, wherein the arrangement of the plurality of plasma torches within the hydrocarbon pyrolysis unit causes an operation of the plurality of plasma torches to create a pyrolysis zone that creates a synthetic gas from the hydrocarbon material that is located within the hydrocarbon pyrolysis unit wherein the synthetic gas so created contains a minimum amount of carbon dioxide.

6. The hydrocarbon pyrolysis unit as set forth in claim 1, wherein the arrangement of the plurality of plasma torches within the hydrocarbon pyrolysis unit causes an operation of the plurality of plasma torches to create a pyrolysis zone that creates a synthetic gas from the hydrocarbon material that is located within the hydrocarbon pyrolysis unit wherein the synthetic gas so created has a desired value of pressure and/or a desired value of temperature.

7. The hydrocarbon pyrolysis unit as set forth in claim 6, further comprising a carbon dioxide recycle loop that recycles carbon dioxide to the hydrocarbon pyrolysis unit from the synthetic gas preparation process of the hydrocarbon pyrolysis unit.

8. (canceled)

9. The hydrocarbon pyrolysis unit as set forth in claim 7, wherein the carbon dioxide recycle loop provides carbon dioxide to a pyrolysis reactor chamber of the hydrocarbon pyrolysis unit.

10. The hydrocarbon pyrolysis unit as set forth in claim 6, further comprising a carbon dioxide recycle loop that recycles carbon dioxide to the hydrocarbon pyrolysis unit from a process that produces a liquid hydrocarbon from the synthetic gas produced by the hydrocarbon pyrolysis unit.

11. The hydrocarbon pyrolysis unit as set forth in claim 1, wherein the arrangement of the plurality of plasma torches within the hydrocarbon pyrolysis unit comprises:
a first plasma torch that has a first plasma jet directed toward a plasma pyrolysis zone within the hydrocarbon pyrolysis unit; and
a second plasma torch that has a second plasma jet directed toward the plasma pyrolysis zone.

12. The hydrocarbon pyrolysis unit as set forth in claim 11, wherein the first plasma torch and the second plasma torch are located within the hydrocarbon pyrolysis unit on opposite sides of the plasma pyrolysis zone.

13. The hydrocarbon pyrolysis unit as set forth in claim 11, further comprising a third plasma torch that has a third plasma jet directed toward the plasma pyrolysis zone.

14. The hydrocarbon pyrolysis unit as set forth in claim 13, wherein the first plasma torch and the second plasma torch and the third plasma torch are aligned within a plane within the hydrocarbon pyrolysis unit that includes the plasma pyrolysis zone.

15. The hydrocarbon pyrolysis unit as set forth in claim 14, wherein the first plasma torch and the second plasma torch and the third plasma torch are aligned within respect to each other at an angle of one hundred twenty degrees.

16-18. (canceled)

19. The hydrocarbon pyrolysis unit as set forth in claim 1, wherein the arrangement of the plurality of plasma torches within the hydrocarbon pyrolysis unit comprises:
a first level of plasma torches comprising at least two first level plasma torches wherein each of the two first level plasma torches has a plasma jet directed toward a first plasma pyrolysis zone within the hydrocarbon pyrolysis unit; and
a second level of plasma torches comprising at least two second level plasma torches wherein each of the two second level plasma torches has a plasma jet directed toward a second plasma pyrolysis zone within the hydrocarbon pyrolysis unit.

20. The hydrocarbon pyrolysis unit as set forth in claim 19, wherein the first plasma pyrolysis zone and the second plasma pyrolysis zone are aligned so that the first plasma pyrolysis zone is located directly over the second plasma pyrolysis zone.

21. The hydrocarbon pyrolysis unit as set forth in claim 19, further comprising a third level of plasma torches comprising at least two third level plasma torches wherein each of the two third level plasma torches has a plasma jet directed toward a third plasma pyrolysis zone within the hydrocarbon pyrolysis unit.

22. The hydrocarbon pyrolysis unit as set forth in claim 21, wherein the first plasma pyrolysis zone and the second plasma pyrolysis zone and the third plasma pyrolysis zone are aligned so that the first plasma pyrolysis zone is located directly over the second plasma pyrolysis zone and wherein the second plasma pyrolysis zone is located directly over the third plasma pyrolysis zone.

23. The hydrocarbon pyrolysis unit as set forth in claim 11, further comprising
a third plasma torch that has a third plasma jet directed toward the plasma pyrolysis zone within the hydrocarbon pyrolysis unit wherein the plasma pyrolysis zone is located below the third plasma torch at a third angle, and
a fourth plasma torch that has a fourth plasma jet directed toward the plasma pyrolysis zone within the hydrocarbon pyrolysis unit wherein the plasma pyrolysis zone is located below the fourth plasma torch at a fourth angle,
wherein the first plasma torch has a first plasma jet directed toward a plasma pyrolysis zone within the hydrocarbon pyrolysis unit wherein the plasma pyrolysis zone is located above the first plasma torch at a first angle, and
the second plasma torch has a second plasma jet directed toward the plasma pyrolysis zone within the hydrocarbon pyrolysis unit wherein the plasma pyrolysis zone is located above the second plasma torch at a second angle, and
the first angle and the second angle and the third angle and the fourth angle are each equal to thirty degrees.

24-26. (canceled)

27. A method for operating a hydrocarbon pyrolysis unit comprising:
placing a plurality of plasma torches in a hydrocarbon pyrolysis unit;
arranging the placement of the plurality of plasma torches in the hydrocarbon pyrolysis unit to create a pyrolysis zone; and
operating the plurality of plasma torches when the plurality of plasma torches are in the arranged placement to increase an efficiency of the pyrolysis zone in breaking atomic bonds of hydrocarbon material that is located within the hydrocarbon pyrolysis unit during a plasma pyrolysis process.

28-35. (canceled)
